(19) United States
(12) Patent Application Publication
(10) Pub. No.: US 2021/0389014 A1
(43) Pub. Date: Dec. 16, 2021

(54) HEATING AND COOLING SYSTEM CONFIGURED TO PROVIDE 100 PERCENT OUTSIDE AIR

(71) Applicant: Moffet Energy Modeling, LLC, Tualatin, OR (US)

(72) Inventor: Tyler Moffet, Tualatin, OR (US)

(21) Appl. No.: 17/346,134

(22) Filed: Jun. 11, 2021

Related U.S. Application Data
(60) Provisional application No. 63/038,623, filed on Jun. 12, 2020.

(51) Int. Cl. F24F 11/81; F24F 7/08; F24F 11/46; F24F 11/74

(52) U.S. Cl. CPC F24F 11/81; F24F 7/08; F24F 2110/10; F24F 11/74; F24F 11/46

(57) ABSTRACT

A system for use with a conditioned space. The system includes an energy transfer device and at least one element. The energy transfer device transfers heat from a hotter air flow and a cooler air flow. The energy transfer device prevents the hotter air flow from mixing with the cooler air flow. A supply one of the hotter and cooler air flows enters into the conditioned space and a return one of the hotter and cooler air flows exits from the conditioned space. The element(s) heat or cool the supply air flow before the supply air flow reaches the conditioned space.

### CROSS REFERENCE TO RELATED APPLICATION

This application claims the benefit of U.S. Provisional Patent Application No. 63/038,623, filed on Jun. 12, 2020, which is incorporated herein by reference in its entirety.

### BACKGROUND OF THE INVENTION

### Field of the Invention

The present invention is directed generally to heating, ventilation, and/or air conditioning (“HVAC”) systems.

### BRIEF DESCRIPTION OF THE SEVERAL VIEWS OF THE DRAWING(S)

Various embodiments in accordance with the present disclosure will be described with reference to the following drawings.

FIG. 1 is a schematic of a system configured for use with a conditioned space.

FIG. 2 is an example control diagram that may be used to implement the system of FIG. 1.

FIG. 3 is a schematic of a system that is a first alternate embodiment of the system of FIG. 1.

FIG. 4 is a schematic of a system that is a second alternate embodiment configured to provide recycled air capabilities.

FIG. 5 is a schematic of a system that is a third alternate embodiment.

FIG. 6 is an example control diagram that may be used to implement the system of FIG. 4 and/or the system of FIG. 5.

FIG. 7 shows the system of FIG. 1 connected to a ducting system.

FIG. 8 illustrates an embodiment of the ducting system in which a main return duct branches and each branch terminates at one or more exhaust registers.

FIG. 9 illustrates an embodiment of the ducting system omitting a main return register because the exhaust register(s) direct(s) a sufficient amount of air into the main return duct such that the main return register is not necessary.

FIG. 10 shows the system of FIG. 4 connected to a ducting system.

FIG. 11 illustrates the system of FIG. 4 installed with an embodiment of the ducting system in which the main return duct branches and each branch terminates at one or more of the exhaust register(s).

Like reference numerals have been used in the figures to identify like components.

### DETAILED DESCRIPTION OF THE INVENTION

FIG. 1 is a schematic of a system 100 configured for use with a conditioned space 102. The conditioned space 102 may be a living space inside a residence, such as a single-family or multi-family dwelling. The system 100 is configured to provide 100% outside air (“OSA”) to the conditioned space 102. In addition to providing 100% OSA, the system 100 illustrated is configured to satisfy a heating load and/or a cooling load of the conditioned space 102.

In the system 100, a first (supply) air flow 104 flows from an outside environment 106 through a supply air duct 107 and into the conditioned space 102. A second (return) air flow 108 flows outwardly from the conditioned space 102 through a return air duct 109 and into the outside environment 106. The system 100 illustrated includes an outside air intake 110, an energy transfer device or heat exchanger 112, a supply fan 114, one or more elements 116, an exhaust or return fan 118, an exhaust air outlet 120, and a controller 122.

The outside air intake 110 provides an opening into the supply air duct 107 that allows the first (supply) air flow 104 to enter the supply air duct 107. The supply air duct 107 extends from the outside air intake 110 through the heat exchanger 112 beyond the supply fan 114 and terminates inside the conditioned space 102. The supply fan 114 is configured to draw the first (supply) air flow 104 into the supply air duct 107, through the heat exchanger 112, passed the element(s) 116, and into the conditioned space 102. The supply fan 114 may be positioned inside and/or in line with the supply air duct 107. While in the embodiment illustrated, the supply fan 114 is positioned after the heat exchanger 112, in alternate embodiments, the supply fan 114 may be positioned between the outside air intake 110 and the heat exchanger 112. The element(s) 116 are configured to adjust the temperature of the first (supply) air flow 104 before the first (supply) air flow 104 enters the conditioned space 102 through an outlet 124 in communication with the conditioned space 102. Operation of the element(s) 116 and/or the supply fan 114 may be controlled by one or more thermostats 130 positioned inside the conditioned space 102, and/or by other controlling devices, such as, but not limited to, carbon dioxide sensors, occupancy sensors, ventilation controllers, etc. The supply fan 114 and/or the return fan 118 may be implemented as variable speed fans configured to increase and decrease airflow as needed. The supply fan 114 and/or the return fan 118 may be used to control the airflow to meet heating and/or cooling demands of the conditioned space 102.

The element(s) 116 may include one or more heating coils or elements and/or one or more cooling coils. By way of a non-limiting example, the element(s) 116 may be implemented as a heat pump coil configured to provide both heating and cooling, a heating element configured to provide gas-source heating, and the like. When the element(s) 116 include the heating coil configured to heat the first (supply) air flow 104, the element(s) 116 may also include a cooling coil configured to cool the first (supply) air flow 104.

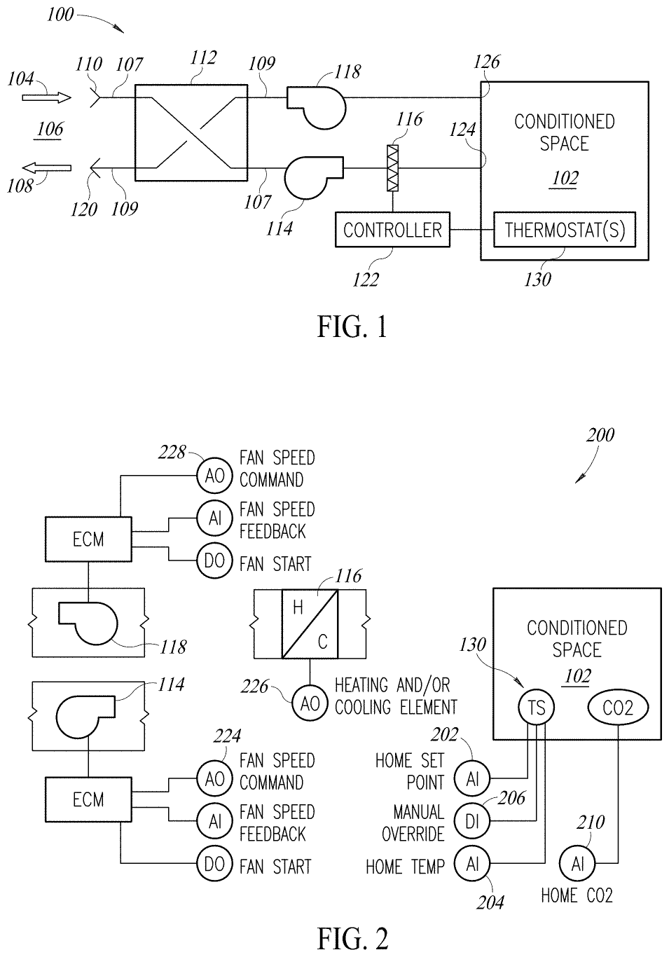

FIG. 2 is an example control diagram 200 that may be used to implement the system 100 (see FIG. 1). In this embodiment, the thermostat(s) 130 has/have been implemented as a thermostat “TS,” which is located in the conditioned space 102 and sends a temperature signal, including a temperature set point 202 and a current temperature 204, to the controller 122 (see FIGS. 1 and 3-6). The thermostat “TS” may contain a manual override 206 that allows a user to manually set the temperature set point 202. A carbon dioxide sensor “CO2” may be located in the conditioned space 102 and may send a carbon dioxide signal that includes current carbon dioxide readings 210 to the controller 122. The controller 122 operates the element(s) 116, the supply fan 114, and/or the return fan 118 based on the temperature and carbon dioxide signals received from the thermostat “TS” and the carbon dioxide sensor “CO2.” In the example illustrated, the temperature set point 202, the current temperature 204, and the current carbon dioxide readings 210 are inputs to the controller 122. The controller 122 may operate the supply fan 114 by sending a control signal 224 to the supply fan 114. The controller 122 may operate the element(s) 116 by sending a control signal 226 to the element(s) 116. The controller 122 may operate the return fan 118 by sending a control signal 228 to the return fan 118.

Referring to FIG. 1, the return air duct 109 has an inlet 126 positioned inside the conditioned space 102. The second (return) air flow 108 enters the return air duct 109 through the inlet 126. The return air duct 109 extends from the inlet 126 passed the return fan 118 through the heat exchanger 112 and terminates at the exhaust air outlet 120. The return fan 118 draws the second (return) air flow 108 into the inlet 126 and propels the second (return) air flow 108 through the heat exchanger 112 and to the exhaust air outlet 120. While in the embodiment illustrated, the return fan 118 is positioned before the heat exchanger 112, in alternate embodiments, the return fan 118 may be positioned between the heat exchanger 112 and the exhaust air outlet 120. The exhaust air outlet 120 provides an opening into the return air duct 109 that allows the second (return) air flow 108 to exit the return air duct 109 and enter the outside environment 106. Operation of the return fan 118 may be controlled by the thermostat(s) 130 positioned inside the conditioned space 102.

Inside the heat exchanger 112, the first and second air flows 104 and 108 do not to mix with one another, but the heat exchanger 112 is configured to provide passive heat recovery. In other words, the heat exchanger 112 transfers heat from whichever of the first and second air flows 104 is warmer to the other.

The controller 122 is configured to obtain a desired temperature (e.g., the temperature set point 202 illustrated in FIG. 2) and a current temperature (e.g., the current temperature 204 illustrated in FIG. 2) of the conditioned space 102 from the thermostat(s) 130 and instruct (e.g., via the control signal 226 illustrated in FIG. 2) the element(s) 116 to heat or cool the first (supply) air flow 104 so that the current temperature of the conditioned space 102 will approach the desired temperature. The controller 122 may also be configured to obtain a desired amount of air flow from the thermostat(s) 130 and/or the carbon dioxide sensor “CO2” (see FIG. 2) and instruct the supply fan 114 (e.g., via the control signal 224 illustrated in FIG. 2) and/or the return fan 118 (e.g., via the control signal 228 illustrated in FIG. 2) to achieve the desired amount of air flow in the conditioned space 102. For example, the controller 122 may use the current carbon dioxide readings 210 (see FIG. 2) to determine the desired amount of air flow in the conditioned space 102. By way of a non-limiting example, if the current carbon dioxide readings 210 (see FIG. 2) exceed a predetermined threshold value, the controller 122 may increase the first (supply) air flow 104 and/or the second (return) air flow 108. The controller 122 may be implemented as component of the thermostat(s) 130 or a separate component that is connected via a wired or wireless connection to the thermostat(s) 130. The controller 122 may be connected to the element(s) 116, the supply fan 114, and/or the return fan 118 via wired or wireless connections.

The system 100 is to be designed to meet the heating and/or cooling demands of the conditioned space 102, while transferring 100% OSA into the conditioned space 102. As mentioned above, operation of the element(s) 116 may be controlled by the thermostat(s) 130 positioned inside the conditioned space 102. When the thermostat(s) 130 inside the conditioned space 102 call for heating or cooling, the system 100 (e.g., the controller 122) will adjust the temperature of the first (supply) air flow 104 to meet the demand. Alternatively or additionally, the system 100 (e.g., the controller 122) may be configured to adjust the temperature of the first (supply) air flow 104 in accordance with a room set point (e.g., the temperature set point 202 illustrated in FIG. 2). Alternatively or additionally, the system 100 (e.g., the controller 122) may be configured to adjust a flow rate of the first (supply) air flow 104 in accordance with a room set point.

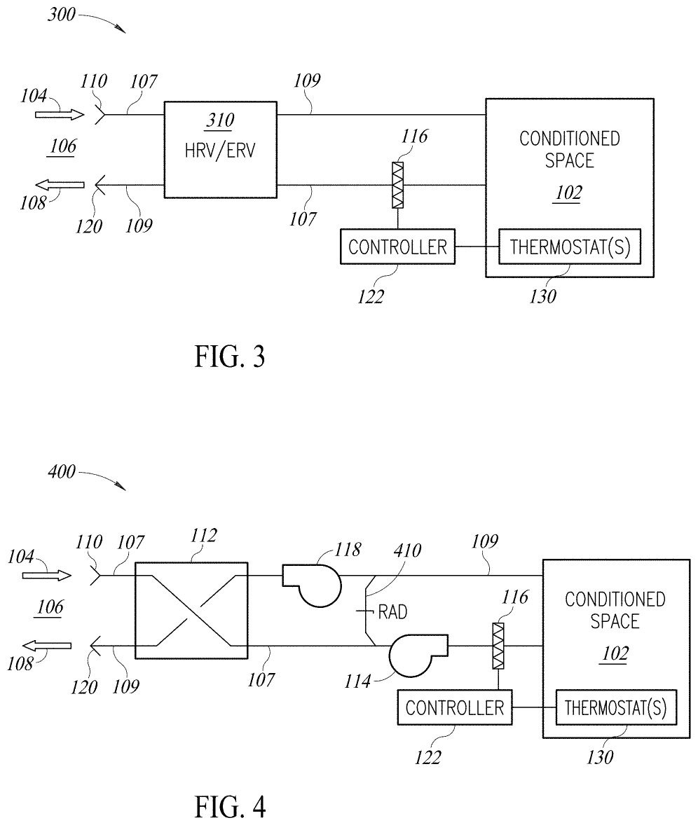

FIG. 3 is a schematic of a system 300 that is an alternate embodiment of the system 100. In the system 300, a ventilation unit 310 replaces the heat exchanger 112, the supply fan 114, and the return fan 118 illustrated in FIG. 1. Referring to FIG. 1, modifying the system 100 by, for example, adding coils, elements, ducting, and the like, will increase static pressure of the system 100. Referring to FIG. 2, the ventilation unit 310 may be configured to handle the additional static pressure of the system 300, if any, as well as to provide adequate air flow to meet the heating load and/or cooling load of the conditioned space 102. The ventilation unit 310 may be implemented as a heat recovery ventilation (“HRV”) unit or an energy recovery ventilation (“ERV”) unit. A HRV unit is configured to recover energy between the first (supply) air flow 104 and the second (return) air flow 108, which are at different temperatures. The HRV unit may include a core unit, channels for the first (supply) air flow 104 and the second (return) air flow 108, and supply and return fans. The core unit may include one or more core heat-exchangers, one or more rotary thermal wheels, one or more fixed plate heat exchangers, one or more heat pipes, one or more run around coils, one or more phase change materials, a combination of any of the forgoing, and the like. Like the heat exchanger 112 (see FIG. 1), the HRV unit may not mix the first (supply) air flow 104 and the second (return) air flow 108 together.

An ERV unit is a type of HRV unit. While HRV units typically transfer only sensible heat, ERV units may transfer both sensible and latent heat as well as moisture. The ERV unit may include one or more core heat-exchangers, one or more rotary enthalpy wheels, one or more fixed plate heat exchangers, one or more heat pipes, one or more run around coils, one or more thermosiphons, twin towers, a combination of any of the forgoing, and the like. Like the heat exchanger 112 (see FIG. 1), the ERV unit may not mix the first (supply) air flow 104 and the second (return) air flow 108 together.

FIG. 4 is a schematic of a system 400 that is an alternate embodiment of the system 100 (see FIG. 1) configured to provide recycled air capabilities. Referring to FIG. 4, the system 400 may include a return air damper (“RAD”) 410 configured to allow some of the second (return) air flow 108 to be combined with the first (supply) air flow 104 and returned to the conditioned space 102. In FIG. 4, the RAD 410 has been positioned before the supply fan 114 and before the return fan 118. However, this is not a requirement.

The RAD 410 may be configured to open to allow a portion of the second (return) air flow 108 to flow into the first (supply) air flow 104. Likewise, the RAD 410 may be configured to close to prevent the second (return) air flow 108 from flowing into and mixing with the first (supply) air flow 104. The RAD 410 may open and close as needed based on energy usage, indoor air quality, outdoor air quality, a combination of any of the forgoing, and the like.

The controller 122 may be connected to the RAD 410 via a wired or wireless connection. In such embodiments, the controller 122 may instruct the RAD 410 (and/or a valve 412 (see FIG. 6) of the RAD 410) to open and close based on energy usage, indoor air quality, outdoor air quality, a combination of any of the forgoing, and the like. For example, the controller 122 may be configured to determine a recycle air content amount based on energy usage, indoor air quality, outdoor air quality, a combination of any of the forgoing, and the like. The indoor air quality may be determined based at least in part on the current carbon dioxide readings 210 (see FIG. 2). The controller 122 may control the valve 412 (see FIG. 6) of the RAD 410, which is configured to be opened by the recycle air content amount.

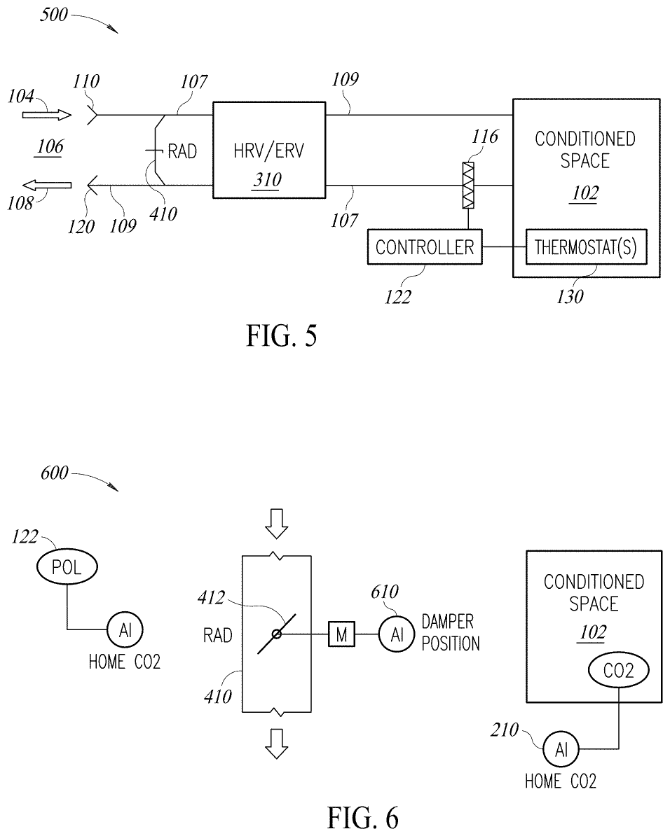

By way of another non-limiting example, FIG. 5 is a schematic of a system 500 that is an alternate embodiment of the system 300 (see FIG. 3). Referring to FIG. 5, the system 500 includes the RAD 410, which allows air to be recycled back to the conditioned space 102. In FIG. 5, the RAD 410 is connected to the supply air duct 107 before the ventilation unit 310 and connected to the return air duct 109 after the ventilation unit 310. However, this is not a requirement. As illustrated in FIG. 5, the controller 122 may be connected to the

RAD 410 via a wired or wireless connection. In such embodiments, the controller 122 may instruct the RAD 410 (and/or the valve 412 (see FIG. 6) of the RAD 410) to open and close based on energy usage, indoor air quality, outdoor air quality, a combination of any of the forgoing, and the like.

FIG. 6 is an example control diagram 600 that may be used to implement the system 400 (see FIG. 4) and/or the system 500 (see FIG. 5). The controller 122 may be configured to receive the current carbon dioxide readings 210 from the carbon dioxide sensor “CO2” and determine an amount of air to recycle back into the conditioned space 102 based at least in part on the current carbon dioxide readings 210. The controller 122 may also be configured to send a control signal that includes a damper position 610 that determines the amount of air that is recycled back to the conditioned space 102 by the RAD 410.

The systems 100, 300, 400, and 500 illustrated in FIGS. 1, 3, 4, and 5, respectively, may each be described as being a heating, ventilation, and air conditioning (“HVAC”) system. Each of the systems 100, 300, 400, and 500 illustrated in FIGS. 1, 3, 4, and 5, respectively, may be implemented as a complete open-system to increase indoor air quality inside the conditioned space 102 (e.g., inside a home). The systems 100, 300, 400, and 500 illustrated in FIGS. 1, 3, 4, and 5, respectively, each includes a passive heat recovery system (e.g., the heat exchanger 112 or the ventilation unit 310) while also providing the element(s) 116 that are configured to satisfy the heating load and/or the cooling load of the conditioned space 102. The systems 100, 300, 400, and 500 illustrated in FIGS. 1, 3, 4, and 5, respectively, each include a control sequence (e.g., implemented by the controller 122) that can monitor indoor temperature, outdoor temperature, indoor air quality, and outdoor air quality (e.g., to maximize efficiency of the system).

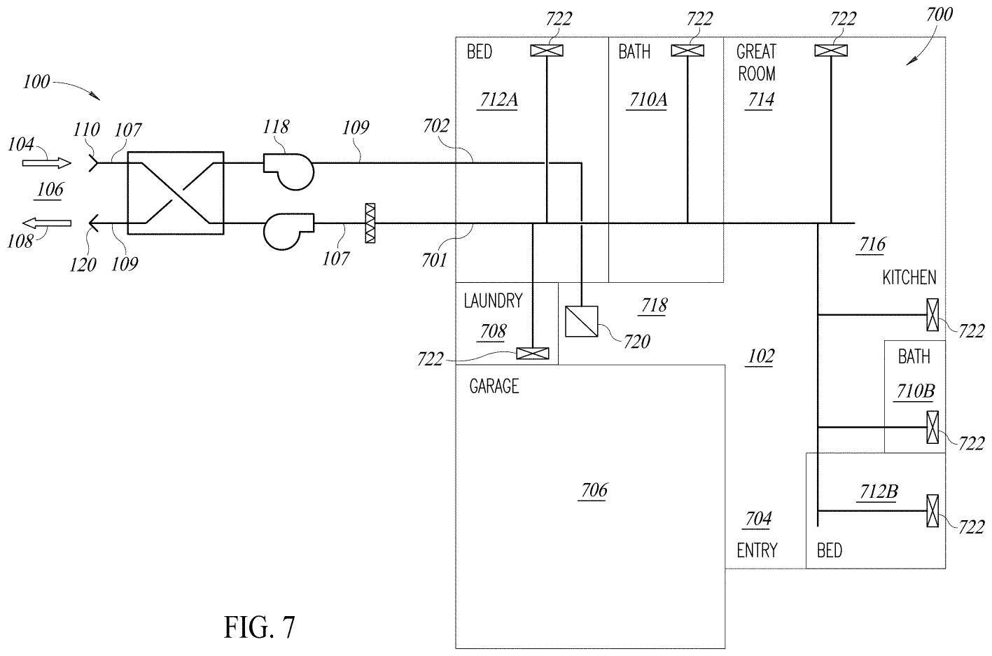

The systems 100, 300, 400, and 500 illustrated in FIGS. 1, 3, 4, and 5, respectively, may be used with a typical central, forced-air ducting system 700 illustrated schematically in FIG. 7. For ease of illustration, FIG. 7 shows the system 100 connected to the ducting system 700. However, any of the systems 100, 300, 400, and 500 illustrated in FIGS. 1, 3, 4, and 5, respectively, may be connected to the ducting system 700. While not illustrated in FIG. 7, the conditioned space 102 also includes the thermostat(s) 130 (see FIGS. 1-5).

Referring to FIG. 7, the ducting system 700 has a main supply duct 701 configured to be connected to the supply air duct 107 of the system 100 and a main return duct 702 configured to be connected to the return air duct 109 of the system 100. The main supply duct 701 is configured to receive the first (supply) air flow 104 from the supply air duct 107 and conduct the first (supply) air flow 104 into the conditioned space 102. In the example embodiment illustrated, the conditioned space 102 includes an entry 704, a garage 706, a laundry room 708, bathrooms 710A and 710B, bedrooms 712A and 712B, a great room 714, and a kitchen 716. Inside the conditioned space 102, the main supply duct 701 branches and each branch terminates at an air outlet 722 (e.g., a register). One of the air outlets 722 is positioned in each of the laundry room 708, the bathrooms 710A and 710B, the bedrooms 712A and 712B, the great room 714, and the kitchen 716. Thus, in this example, the system 100 and the ducting system 700 may deliver 100% OSA to each of the laundry room 708, the bathrooms 710A and 710B, the bedrooms 712A and 712B, the great room 714, and the kitchen 716.

The main return duct 702 is configured to receive the second (return) air flow 108 from the conditioned space 102 and conduct the second (return) air flow 108 into the return air duct 109 of the system 100. Inside the conditioned space 102, a main return register 720 may be positioned at an inlet into the main return duct 702. The main return register 720 is configured to blow air from the conditioned space 102 into the main return duct 702 and toward the exhaust air outlet 120 of the system 100. In the example embodiment illustrated, the main return register 720 is positioned in a hallway 718 outside the laundry room 708.

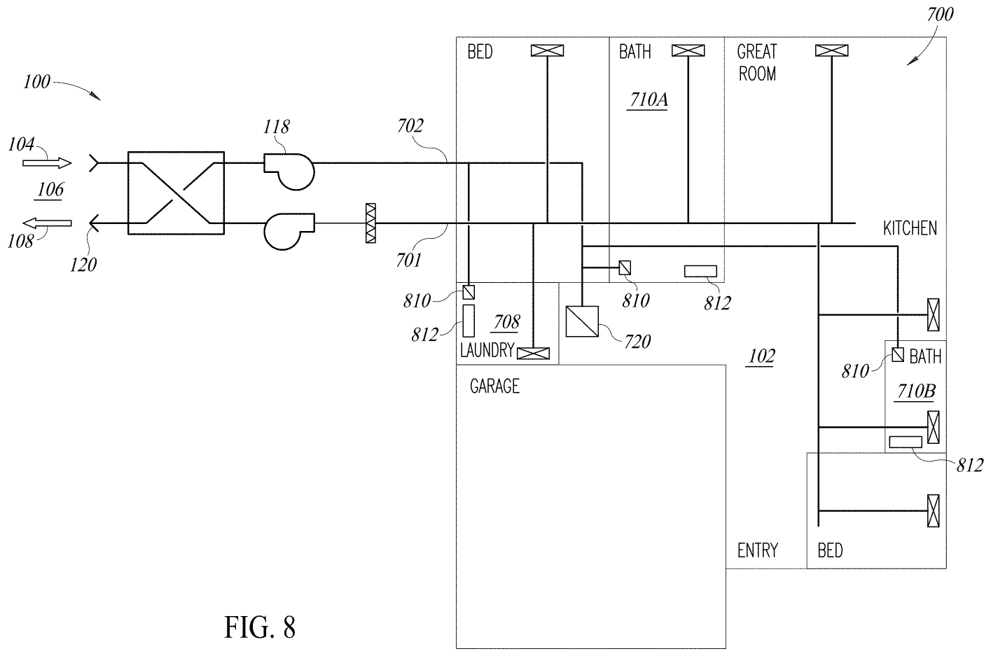

FIG. 8 illustrates an embodiment of the ducting system 700 in which the main return duct 702 branches and each branch terminates at one or more exhaust registers 810. The exhaust register(s) 810 allow air from the conditioned space 102 to be pulled into the main return duct 702 by the return fan 118, which blows this air toward the exhaust air outlet 120 of the system 100. In this manner, rooms that typically require spot or exhaust fans (such as bathrooms and laundry rooms) configured to direct air outside the conditioned space 102 instead include the exhaust register(s) 810. The exhaust register(s) 810 each functions as an exhaust port for the ducting system 700 through which the return fan 118 pulls exhaust into the main return duct 702. In other words, conventional spot or exhaust fans are not needed. In embodiments including more than one exhaust register, the return fan 118 pulls the exhaust into the main return duct 702 through the exhaust registers simultaneously. Thus, the main return duct 702 functions as a single central return and the return fan 118 replaces the spot or exhaust fan(s). In the example illustrated, the main return duct 702 branches into the laundry room 708 and the bathrooms 710A and 710B. Thus, at least one of the exhaust register(s) 810 is positioned in each of the laundry room 708 and the bathrooms 710A and 710B. Each location (e.g., the laundry room 708 and the bathrooms 710A and 710B) that has one of the exhaust register(s) 810 may include a switch 812 configured to control the operation of the return fan 118 (e.g., turn the return fan 118 on and off). The branches connected to the main return duct 702 may be sized to ensure that the return fan 118 pulls a sufficient amount of air from each location that has one of the exhaust register(s) 810.

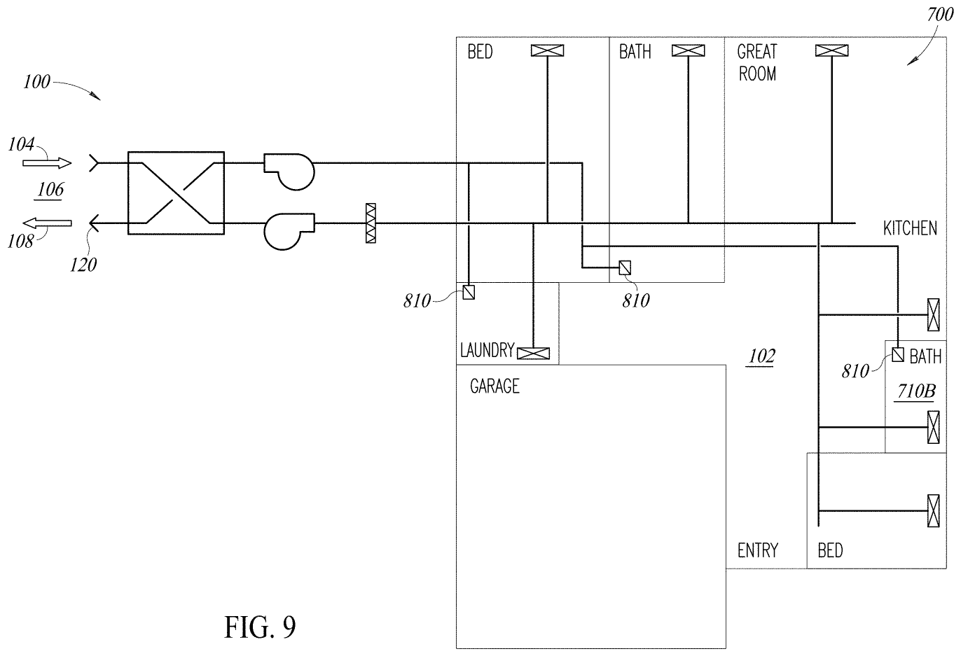

As shown in FIG. 9, the ducting system 700 may omit the main return register 720 (shown in FIGS. 7, 8, and 10) if proper air distribution can be maintained without it. In other words, the exhaust register(s) 810 may be configured to direct a sufficient amount of air into the main return duct 702 such that the main return register 720 (shown in FIGS. 7, 8, and 10) is not necessary.

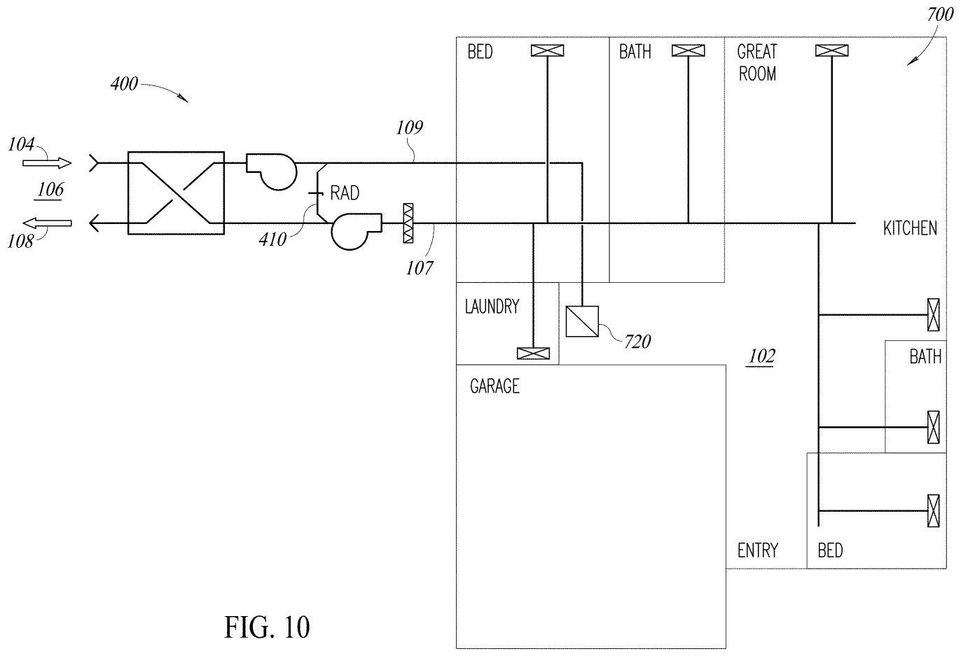

FIG. 10 illustrates the system 400 connected to the ducting system 700. In this example, the system 400 provides room level exhaust (e.g., using spot fans) that is not directed into the return air duct 109 of the system 100. In other words, this embodiment may omit the exhaust register(s) 810 (see FIG. 8) to prevent exhaust air (e.g., from the restrooms) from being recycled back into the conditioned space 102 by the RAD 410.

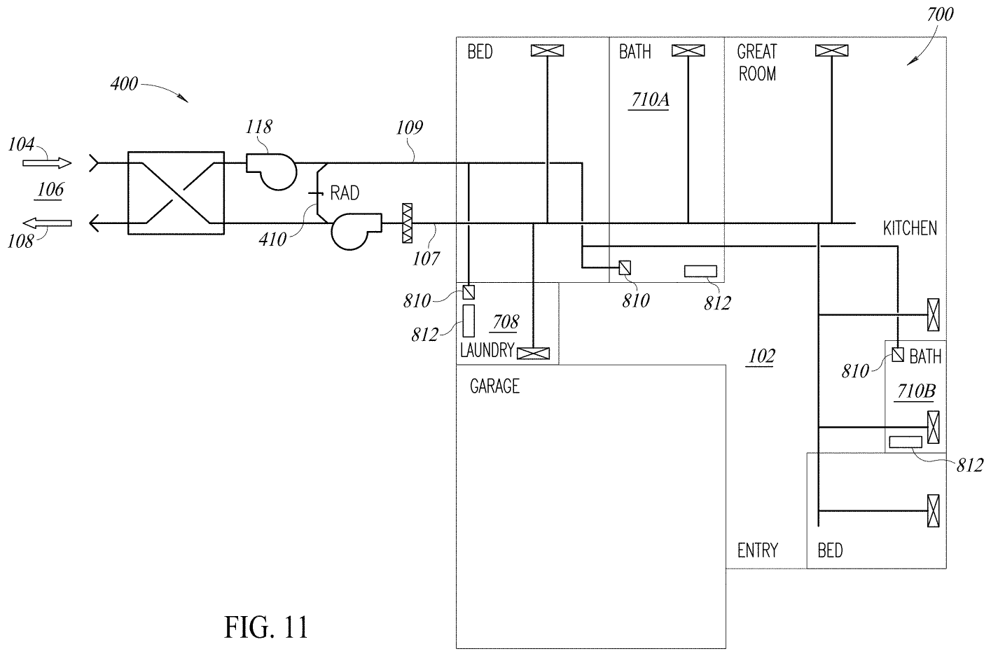

FIG. 11 illustrates the system 400 installed with the embodiment of the ducting system 700 in which the main return duct 702 branches and each branch terminates at one or more of the exhaust register(s) 810. As shown in FIG. 11, the ducting system 700 may omit the main return register 720 (shown in FIGS. 7, 8, and 10) if proper air distribution can be maintained without it. Thus, the RAD 410 may be used with the exhaust register(s) 810 that take the place of conventional exhaust fans and may be installed in restrooms (e.g., the bathrooms 710A and 710B) and laundry rooms (e.g., the laundry room 708). The switches 812 configured to control the operation of the return fan 118 (e.g., turn the return fan 118 on and off) may also be wired to control the operation of the RAD 410. For example, when one of the switches 812 turns on the return fan 118, that switch may also close the RAD 410 to prevent the second (return) air flow 108 from flowing into and mixing with the first (supply) air flow 104, which prevents the exhaust air (e.g., from the laundry room 708, the bathroom 710A, the bathroom 710B, and the like) from being recycled back into the conditioned space 102. Thus, the switches 812 configured to turn on the return fan 118 (e.g., the switch 812 positioned in the bathroom 710A) will also close the RAD 410. On the other hand, when the return fan 118 is turned off by the switches 812, the switches 812 open the RAD 410 to allow a portion of the second (return) air flow 108 to flow into and mix with the first (supply) air flow 104.

The controller 122 may obtain information from outside air (e.g., an outside temperature) and/or indoor air. This information may include temperature information (e.g., the temperature set point 202, the current temperature 204, and the like), the current carbon dioxide readings 210, weather forecasts, and the like. This information may be obtained from one or more sensors, such as the thermostat(s) 130, the carbon dioxide sensor “CO2,” an outside temperature sensor, one or more humidity sensors, and the like. Thus, the system 100 may be configured to pull information from one or more sources and use that information to keep the conditioned space 102 (e.g., a home) comfortable and/or safe. The system 100 may be configured to do so while using minimal energy.

The controller 122 may be implemented using a standard HVAC control system, a single home heating controller, and the like. By way of non-limiting examples, the controller 122 may be implemented as a microcontroller, a microprocessor, and the like. The controller 122 may include one or more electrical switches, one or more thermostats (e.g., the thermostat(s) 130), one or more temperature sensors that each measure a temperature of indoor air and/or outdoor air, one or more carbon dioxide sensors that each measure carbon dioxide concentration present in indoor air and/or outdoor air, one or more pollution concentration sensors that each measure a concentration of one or more pollutants in indoor air and/or outdoor air, and the like. Operations of the controller 122 may be controlled by controller executable instructions implemented in software, hardware, and/or firmware. The controller 122 may include memory that stores the controller executable instructions that when executed by one or more processors of the controller 122 cause the one or more processors to perform all or portions of one or more of the methods described above. Such instructions may be stored on one or more non-transitory computer-readable media. For example, the controller executable instructions may cause the controller 122 to transmit one or more of the control signals 224-228 and/or issue instructions to the RAD 410, the valve 412, the supply fan 114, and/or the element(s) 116 described herein.

At least one embodiment of the disclosure can be described in view of the following clauses.

1. A system for use with a conditioned space, the system comprising:

a supply air duct to conduct a supply air flow from an outside environment to the conditioned space;

a return air duct to conduct a return air flow from the conditioned space to the outside environment;

an energy transfer device to transfer heat from a hotter one of the supply air flow and the return air flow to a cooler one of the supply air flow and the return air flow, the energy transfer device preventing the supply air flow from mixing with the return air flow; and

at least one element to condition the supply air flow before the supply air flow reaches the conditioned space, conditioning the supply air flow comprising one of heating or cooling the supply air flow.

2. The system of clause 1, wherein the energy transfer device is a heat exchanger, a heat recovery ventilation (“HRV”) unit, or an energy recovery ventilation (“ERV”) unit.

3. The system of clause 1 or 2, further comprising: a supply fan to draw the supply air flow into the supply air duct; and a return fan to draw the return air flow into the return air duct.

4. The system of any one of the clauses 1-3, further comprising: a return air damper to direct a portion of the return air flow in the return air duct into the supply air duct.

5. The system of clause 4, further comprising: a controller connected to the return air damper to instruct a valve of the return air damper to open and close based at least in part on energy usage, indoor air quality, or outdoor air quality, opening and closing of the valve determining an amount of the return air flow directed into the supply air duct.

6. The system of clause 4, further comprising: a carbon dioxide sensor positionable in the conditioned space to monitor carbon dioxide therein; and a controller connectable to the return air damper and the carbon dioxide sensor, the carbon dioxide sensor providing a carbon dioxide signal to the controller, the controller instructing a valve of the return air damper to open and close based at least in part on the carbon dioxide signal, opening and closing of the valve determining an amount of the return air flow directed into the supply air duct.

7. The system of any one of the clauses 1-6, further comprising: a return fan to draw the return air flow into the return air duct; and a plurality of exhaust registers positioned in a plurality of rooms within the conditioned space, the return air duct comprising a main portion and a plurality of branches, each of the plurality of branches terminating at a different one of the plurality of exhaust registers, the return fan being positioned in the main portion and spaced apart from each of the plurality of exhaust registers, each of the plurality of exhaust registers being without an exhaust fan.

8. The system of any one of the clauses 1-7, wherein the at least one element comprises at least one heating coil, at least one heating element, or at least one cooling coil.

9. The system of any one of the clauses 1-7, wherein the at least one element comprises a heat pump coil providing both heating and cooling.

10. The system of any one of the clauses 1-9, wherein the at least one element comprises a heating element providing gas-source heating.

11. The system of any one of the clauses 1-10, further comprising:

at least one air moving device to adjust the supply air flow, the return air flow, or both the supply air flow and the return air flow;

a controller connected to the at least one air moving device and the at least one element;

a carbon dioxide sensor to be positioned in the conditioned space and monitor carbon dioxide therein, the carbon dioxide sensor providing a carbon dioxide signal to the controller; and

a thermostat to be positioned in the conditioned space and monitor a temperature therein, the thermostat providing a temperature signal to the controller, the controller controlling operation of the at least one air moving device and the at least one element based at least in part on the carbon dioxide signal and the temperature signal.

12. A system for use with a conditioned space, the system comprising:

an energy transfer device to transfer heat from a hotter air flow and a cooler air flow, the energy transfer device preventing the hotter air flow from mixing with the cooler air flow, a supply one of the hotter and cooler air flows comprising one hundred percent outside air, and a return one of the hotter and cooler air flows comprising air obtained from the conditioned space; and

at least one element to heat or cool the supply air flow before the supply air flow reaches the conditioned space.

13. The system of clause 12, wherein the energy transfer device is a heat exchanger, a heat recovery ventilation (“HRV”) unit, or an energy recovery ventilation (“ERV”) unit.

14. The system of clause 12 or 13, further comprising: supply and return fans to draw the supply and return air flows, respectively, into the energy transfer device.

15. The system of any one of the clauses 12-14, further comprising: a return air damper to direct a portion of the return air flow in into the supply air flow before the supply air flow reaches the conditioned space.

16. The system of clause 15, further comprising: a controller connected to the return air damper and instructing a valve of the return air damper to open and close based at least in part on energy usage, indoor air quality, or outdoor air quality, opening and closing of the valve determining an amount of the return air flow directed into the supply air flow.

17. The system of clause 15, further comprising: a carbon dioxide sensor to be positioned in the conditioned space and monitor carbon dioxide therein; and a controller connected to the return air damper and the carbon dioxide sensor, the carbon dioxide sensor providing a carbon dioxide signal to the controller, the controller instructing a valve of the return air damper to open and close based at least in part on the carbon dioxide signal, opening and closing of the valve determining an amount of the return air flow directed into the supply air flow.

18. The system of any one of the clauses 12-17, further comprising: a return fan to draw the return air flow into a return air duct; and a plurality of exhaust registers positioned in a plurality of rooms within the conditioned space, the return air duct comprising a main portion and a plurality of branches, each of the plurality of branches terminating at a different one of the plurality of exhaust registers, the return fan being positioned in the main portion and spaced apart from each of the plurality of exhaust registers, each of the plurality of exhaust registers being without an exhaust fan.

19. The system of any one of the clauses 12-18, wherein the at least one element comprises at least one heating coil, at least one heating element, or at least one cooling coil.

20. The system of any one of the clauses 12-19, wherein the at least one element comprises a heat pump coil providing both heating and cooling.

21. The system of any one of the clauses 12-20, wherein the at least one element comprises a heating element providing gas-source heating.

22. The system of any one of the clauses 12-21, further comprising:

at least one air moving device to adjust the supply air flow, the return air flow, or both the supply and return air flows;

a controller connected to the at least one air moving device and the at least one element;

a carbon dioxide sensor to be positioned in the conditioned space and monitor carbon dioxide therein, the carbon dioxide sensor providing a carbon dioxide signal to the controller; and

a thermostat to be positioned in the conditioned space and monitor a temperature therein, the thermostat providing a temperature signal to the controller, the controller controlling operation of the at least one air moving device and the at least one element based at least in part on the carbon dioxide signal and the temperature signal.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

As used herein, a term joining items in a series (e.g., the term “or,” the term “and,” or the like) does not apply to the entire series of items, unless specifically stated otherwise or otherwise clearly contradicted by context. For example, the phrase “a plurality of A, B, and C” (with or without the Oxford comma) refers to a subset including at least two of the recited items in the series. Thus, the phrase refers to (1) at least one A and at least one B but not C, (2) at least one A and at least one C but not B, (3) at least one B and at least one C but not A, and (4) at least one A and at least one B and at least one C. Similarly, the phrase “a plurality of A, B, or C” (with or without the Oxford comma) refers to a subset including at least two of the recited items in the series. Thus, this phrase also refers to (1) at least one A and at least one B but not C, (2) at least one A and at least one C but not B, (3) at least one B and at least one C but not A, and (4) at least one A and at least one B and at least one C.

By away of another example, conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. A system for use with a conditioned space, the system comprising:
a supply air duct to conduct a supply air flow from an outside environment to the conditioned space;
a return air duct to conduct a return air flow from the conditioned space to the outside environment;
an energy transfer device to transfer heat from a hotter one of the supply air flow and the return air flow to a cooler one of the supply air flow and the return air flow, the energy transfer device preventing the supply air flow from mixing with the return air flow; and
at least one element to condition the supply air flow before the supply air flow reaches the conditioned space, conditioning the supply air flow comprising one of heating or cooling the supply air flow.

2. The system of claim 1, wherein the energy transfer device is a heat exchanger, a heat recovery ventilation (“HRV”) unit, or an energy recovery ventilation (“ERV”) unit.

3. The system of claim 1, further comprising:
a supply fan to draw the supply air flow into the supply air duct; and
a return fan to draw the return air flow into the return air duct.

4. The system of claim 1, further comprising:
a return air damper to direct a portion of the return air flow in the return air duct into the supply air duct.

5. The system of claim 4, further comprising:
a controller connected to the return air damper to instruct a valve of the return air damper to open and close based at least in part on energy usage, indoor air quality, or outdoor air quality, opening and closing of the valve determining an amount of the return air flow directed into the supply air duct.

6. The system of claim 4, further comprising:
a carbon dioxide sensor positionable in the conditioned space to monitor carbon dioxide therein; and
a controller connectable to the return air damper and the carbon dioxide sensor, the carbon dioxide sensor providing a carbon dioxide signal to the controller, the controller instructing a valve of the return air damper to open and close based at least in part on the carbon dioxide signal, opening and closing of the valve determining an amount of the return air flow directed into the supply air duct.

7. The system of claim 1, further comprising:
a return fan to draw the return air flow into the return air duct; and
a plurality of exhaust registers positioned in a plurality of rooms within the conditioned space, the return air duct comprising a main portion and a plurality of branches, each of the plurality of branches terminating at a different one of the plurality of exhaust registers, the return fan being positioned in the main portion and spaced apart from each of the plurality of exhaust registers, each of the plurality of exhaust registers being without an exhaust fan.

8. The system of claim 1, wherein the at least one element comprises at least one heating coil, at least one heating element, or at least one cooling coil.

9. The system of claim 1, wherein the at least one element comprises a heat pump coil providing both heating and cooling.

10. The system of claim 1, wherein the at least one element comprises a heating element providing gas-source heating.

11. The system of claim 1, further comprising:
at least one air moving device to adjust the supply air flow, the return air flow, or both the supply air flow and the return air flow;
a controller connected to the at least one air moving device and the at least one element;
a carbon dioxide sensor to be positioned in the conditioned space and monitor carbon dioxide therein, the carbon dioxide sensor providing a carbon dioxide signal to the controller; and
a thermostat to be positioned in the conditioned space and monitor a temperature therein, the thermostat providing a temperature signal to the controller, the controller controlling operation of the at least one air moving device and the at least one element based at least in part on the carbon dioxide signal and the temperature signal.

12. A system for use with a conditioned space, the system comprising:
an energy transfer device to transfer heat from a hotter air flow and a cooler air flow, the energy transfer device preventing the hotter air flow from mixing with the cooler air flow, a supply one of the hotter and cooler air flows comprising one hundred percent outside air, and a return one of the hotter and cooler air flows comprising air obtained from the conditioned space; and
at least one element to heat or cool the supply air flow before the supply air flow reaches the conditioned space.

13. The system of claim 12, wherein the energy transfer device is a heat exchanger, a heat recovery ventilation (“HRV”) unit, or an energy recovery ventilation (“ERV”) unit.

14. The system of claim 12, further comprising:
supply and return fans to draw the supply and return air flows, respectively, into the energy transfer device.

15. The system of claim 12, further comprising:
a return air damper to direct a portion of the return air flow in into the supply air flow before the supply air flow reaches the conditioned space.

16. The system of claim 15, further comprising:
a controller connected to the return air damper and instructing a valve of the return air damper to open and close based at least in part on energy usage, indoor air quality, or outdoor air quality, opening and closing of the valve determining an amount of the return air flow directed into the supply air flow.

17. The system of claim 15, further comprising:
a carbon dioxide sensor to be positioned in the conditioned space and monitor carbon dioxide therein; and
a controller connected to the return air damper and the carbon dioxide sensor, the carbon dioxide sensor providing a carbon dioxide signal to the controller, the controller instructing a valve of the return air damper to open and close based at least in part on the carbon dioxide signal, opening and closing of the valve determining an amount of the return air flow directed into the supply air flow.

18. The system of claim 12, further comprising:
a return fan to draw the return air flow into a return air duct; and
a plurality of exhaust registers positioned in a plurality of rooms within the conditioned space, the return air duct comprising a main portion and a plurality of branches, each of the plurality of branches terminating at a different one of the plurality of exhaust registers, the return fan being positioned in the main portion and spaced apart from each of the plurality of exhaust registers, each of the plurality of exhaust registers being without an exhaust fan.

19. The system of claim 12, wherein the at least one element comprises at least one heating coil, at least one heating element, or at least one cooling coil.

20. The system of claim 12, wherein the at least one element comprises a heat pump coil providing both heating and cooling.

21. The system of claim 12, wherein the at least one element comprises a heating element providing gas-source heating.

22. The system of claim 12, further comprising:
at least one air moving device to adjust the supply air flow, the return air flow, or both the supply and return air flows;
a controller connected to the at least one air moving device and the at least one element;
a carbon dioxide sensor to be positioned in the conditioned space and monitor carbon dioxide therein, the carbon dioxide sensor providing a carbon dioxide signal to the controller; and
a thermostat to be positioned in the conditioned space and monitor a temperature therein, the thermostat providing a temperature signal to the controller, the controller controlling operation of the at least one air moving device and the at least one element based at least in part on the carbon dioxide signal and the temperature signal.
